(19) United States
(12) Patent Application Publication
(10) Pub. No.: US 2009/0160936 A1
(43) Pub. Date: Jun. 25, 2009

(54) METHODS AND APPARATUS FOR OPERATING A VIDEO CAMERA ASSEMBLY

(76) Inventor: Kenneth McCormack, Albany, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/963,410

(22) Filed: Dec. 21, 2007

(51) Int. Cl. H04N 7/18

(52) U.S. Cl. 348/143; 348/E07.085

(57) ABSTRACT

Method and apparatus for a video camera assembly are provided. The video camera assembly includes a pan mechanism rotatable about a pan axis, a video camera mounted on the pan mechanism such that the video camera is rotatable about the pan axis, and a controller communicatively coupled to the pan mechanism and the video camera. The controller is configured to control the rotation of the video camera about the pan axis at a predetermined speed, acquire a plurality of images from the video camera at a predetermined rate, and display the acquired images panoramically.

### BACKGROUND OF THE DISCLOSURE

This disclosure relates generally to video surveillance systems and, more particularly, to generating quasi-panoramic views of images acquired using a single video camera assembly.

At least some known video surveillance systems include one or more video cameras mounted in a housing along with a pan, tilt, and zoom (PTZ) assembly. The PTZ assembly permits controlling a movement of the camera to align a viewing axis of the camera with an object of interest or location of interest. The zoom portion of the mechanism may be used to adjust a field of view of the camera. The housing protects the camera from the environment in the location where the camera and PTZ assembly are mounted.

Video cameras are typically panned and tilted along axes to point the camera toward an area of interest. A zoom setting is adjusted to modify the field of view of the camera. Panning and tilting is done at a relatively slow speed so that the user can visually discern objects of interest in the field of view. Camera pan and tilt units can generally move the camera faster than the user's eye can discern objects in the field of view. However, panning and tilting slowly to allow a user to discern objects of interest in the field of view may permit objects or activities to occur in blind spots of the camera, for example, areas outside the camera field of view. Increasing the speed to improve coverage of these blind spots may cause motion blur of the image and/or change the field of view of the camera faster than the user's eye can discern the objects in the image.

### BRIEF DESCRIPTION OF THE DISCLOSURE

In one embodiment, a video camera assembly includes a pan mechanism rotatable about a pan axis, a video camera mounted on the pan mechanism such that the video camera is rotatable about the pan axis, and a controller communicatively coupled to the pan mechanism and the video camera. The controller is configured to control the rotation of the video camera about the pan axis at a predetermined speed, acquire a plurality of images from the video camera at a predetermined rate, and display the acquired images panoramically.

In another embodiment, a method of operating a video camera assembly is provided. The video camera assembly includes a video camera and a pan mechanism. The pan mechanism is configured to rotate the video camera about a pan axis. The method includes rotating the video camera about the pan axis, acquiring a plurality of images from the video camera during the rotation wherein the plurality of images includes a field of view, and outputting a panoramic view of the acquired images.

In yet another embodiment, a video system includes a video camera assembly including a video camera and at least one of a pan mechanism, a tilt mechanism, and a zoom for defining a field of view of the camera and a controller communicatively coupled to the video camera assembly. The controller is configured to rotate the video camera continuously about the pan axis at a substantially constant rotational speed during a first mode of operation, acquire a plurality of sequential images from the video camera during the rotation wherein the plurality of images includes a field of view that each overlaps a field of view of sequentially adjacent ones of the plurality of images, outputting the acquired images in a panoramic view, and update the images in the panoramic view each n rotations, where n is a whole number.

### BRIEF DESCRIPTION OF THE DRAWINGS

FIG. 1 is a schematic view of an exemplary video surveillance system in accordance with an embodiment of the present disclosure;

FIG. 2 is a perspective view of a plurality of images such as may be acquired by the video camera shown in FIG. 1; and

FIG. 3 is a flow diagram an exemplary method of operating the video camera assembly that may be used with the system shown in FIG. 1.

### DETAILED DESCRIPTION OF THE DISCLOSURE

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to a preferred embodiment, namely, generating a panoramic view of an area of interest from a plurality of images acquired during a rotation of an imager about its pan axis. However, it is contemplated that this disclosure has general application to generating a variety of image presentations in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

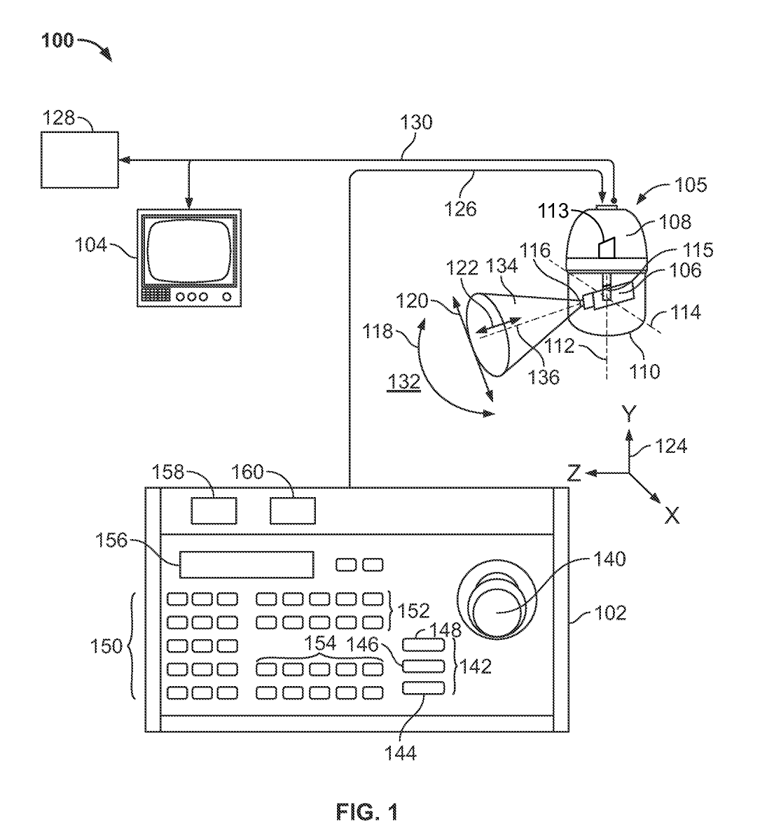

FIG. 1 is a schematic view of an exemplary video surveillance system 100 in accordance with an embodiment of the present disclosure. Video surveillance system 100 includes a controller 102, a display monitor 104, and a video camera assembly 105. Typically, a camera 106 is housed in an enclosure 108 having a dome 110 for protecting camera 106 from the environment where camera 106 is located. In one embodiment, dome 110 is tinted to allow camera 106 to acquire images of the environment outside of enclosure 108 and simultaneously prevent individuals in the environment being observed by camera 106 from determining the orientation of camera 106. In various alternative embodiments, dome 110 is not tinted. In the exemplary embodiment, camera 106 includes capabilities to pan about a vertical axis 112, tilt about a tilt axis 114, and control a lens assembly 116 to cause camera 106 to zoom. For example, video camera assembly 105 includes a pan mechanism 113 including a pan motor and encoder and a tilt mechanism 115 including a tilt motor and encoder. The encoders determine an angular position of the associated pan or tilt motor to generate position signals that are used with a zoom setting to determine an area in the field of view. Panning movement of camera 106 is represented by an arrow 118, tilting movement of camera 106 is represented by arrow 120 and the changing of the focal length of lens assembly 116 of camera 106, i.e., zooming, is represented by arrow 122. As shown with reference to a coordinate system 124, panning motion may track movement along the x-axis, tilting motion may track movement along the y-axis and focal length adjustment may be used to track movement along the z-axis. Signals representing commands to control such capabilities are transmitted from controller 102 through a control data line 126. Image data signals are transmitted from camera 106 to display monitor 104 and a storage device 128 through a video or data network 130.

Lens assembly 116 views an area of a location 132, which may be remote from controller 102 and is in a field of view 134 and along a viewing axis 136 of lens assembly 116. Images of location 132 are converted by camera 106 into an electrical video signal, which is transmitted to display monitor 104.

In the exemplary embodiment, controller 102 includes an X-Y control joystick 140 that is used to generate pan and tilt commands. A plurality of rocker-type switches 142 are used to control a zoom 144, a focus 146, and an iris 148 of lens assembly 116. In an alternative embodiment, joystick 140 includes a twist actuation that is used to control the zoom of camera 106. Joystick 140 may also incorporate triggers and/or buttons to facilitate operating various controls associated with system 100. Controller 102 also includes a numeric keypad 150 for entering numbers and values. In an alternative embodiment, controller 102 may include an alpha or alphanumeric keypad (not shown) for entering text as well as numbers. Controller 102 further includes a plurality of preset switches 152 that may be programmed to execute macros that automatically control the actions of camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected camera.

A processor 158 receives programmed instructions, from software, firmware, and data from memory 160 and performs various operations using the data and instructions. Processor 158 may include an arithmetic logic unit (ALU) that performs arithmetic and logical operations and a control unit that extracts instructions from memory 160 and decodes and executes them, calling on the ALU when necessary. Memory 160 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 160 may include an operating system, which executes on processor 158. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 160 may include storage locations for the preset macro instructions that may be accessible using one of the plurality of preset switches 142.

As used herein, the terms “software” and “firmware” are interchangeable, and include any computer program stored in memory for execution by processor 158, including RAM memory, ROM memory, EPROM memory, EEPROM memory, and non-volatile RAM (NVRAM) memory. The above memory types are exemplary only, and are thus not limiting as to the types of memory usable for storage of a computer program.

In various embodiments, processor 158 and memory 160 are located external to camera 106 such as in controller 102 or in a PC or other standalone or mainframe computer system capable of performing the functions described herein.

In the exemplary embodiment, video surveillance system 100 is a single camera application, however, various embodiments of the present disclosure may be used within a larger surveillance system having additional cameras which may be either stationary or moveable cameras or some combination thereof to provide coverage of a larger or more complex surveillance area. In an alternative embodiment, one or more video recorders (not shown) are connected to controller 102 to provide for recording of video images captured by camera 106 and other cameras in system 100.

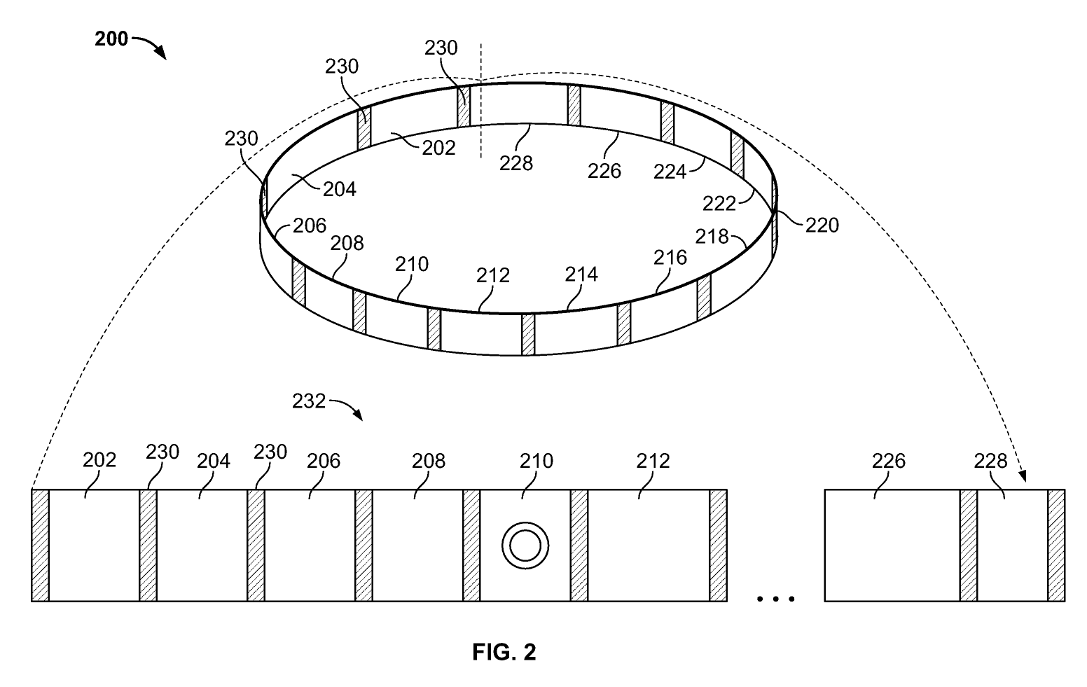

FIG. 2 is a perspective view of a plurality of images 200 such as may be acquired by camera 106 (shown in FIG. 1). In the exemplary embodiment, plurality of images 200 comprises a series of individual images 202-228 sequentially acquired during a single revolution of camera 106 about pan axis 112. In various other embodiments, other numbers of individual images may be sequentially acquired during a single revolution of camera 106 about pan axis 112. Each subsequent image is acquired with a predetermined overlap 230 of the previous image. The amount of overlap 230 is determined based on the content of the images in the overlap 230. In the exemplary embodiment, the content of the images in the overlap 230 permit registration of adjacent images into a seamless panoramic view 232. If the content is relatively devoid of features the registration algorithm may be unable to register the adjacent images with a relatively high degree of certainty, in which case, the registration algorithm indicates that the registration may not achieve a predetermined level of certainty. Controller 102 then determines a revised overlap 230 to include enough features in the images in overlap 230 to permit an accurate registration of the adjacent images.

Typically, images that are displayed to a human viewer are refreshed or updated approximately thirty times per second. This “frame rate” permits viewing the image sequence without noticeable “flicker” for most humans. If the frame rate is less, for example, twenty five frames per second, a noticeable flicker may make viewing the video sequence uncomfortable. A frame rate faster than thirty frames per second may simply be wasting the processing power of processor 158. Additionally, to conserve processing power each individual image 202-228 may only be processed every other, every third, or every fourth rotation of camera 106.

Panoramic view 232 includes a number n of images that are acquired as described above displayed as a series of n quasi-stationary images each having a field of view that encompasses up to 360/n° about camera 106. Each image is quasi-stationary because it appears to the user to be acquired using a stationary camera pointed at the respective field of view. However, camera 106 is continuously rotating during the acquisition. In one embodiment, images 202-228 may be sequentially acquired using an elapsed time between image acquisitions. In another embodiment, images 202-228 may be acquired or sampled when pan mechanism 113 indicate that the camera is positioned in a determined location.

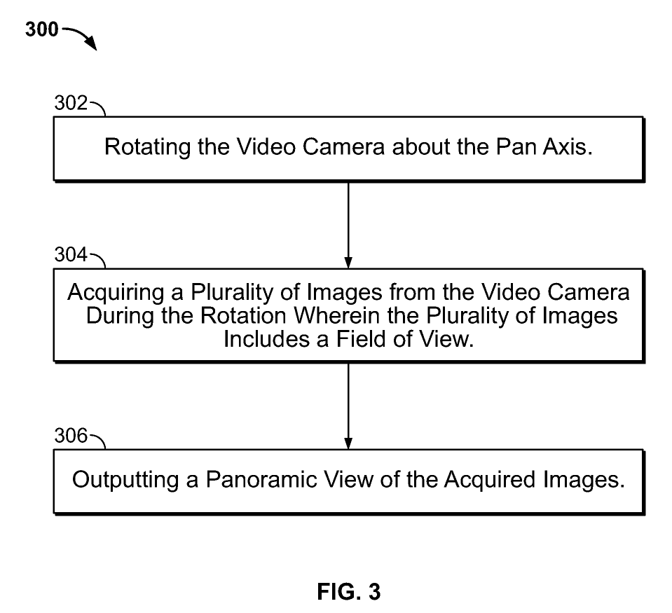

FIG. 3 is a flow diagram an exemplary method 300 of operating video camera assembly 105 that may be used with system 100 (shown in FIG. 1). In the exemplary embodiment, video camera assembly 105 includes video camera 106, pan mechanism 113, and a zoom for defining a field of view of camera 106. Pan mechanism 113 is configured to rotate video camera 106 about pan axis 112. Method 300 includes rotating 302 the video camera about pan axis 112, acquiring 304 a plurality of images from video camera 106 during the rotation, and outputting 306 a panoramic view 232 of the acquired images. Method 300 also includes selecting a speed of rotation setting. The selection may be made by a user through controller 102 or may be received through network 130. In an alternative embodiment, the speed of rotation setting is determined based on a field of view setting. For example, a zoomed out setting corresponds to a relatively larger field of view and fewer individual images n may provide 360° coverage. Similarly, a zoomed in setting corresponds to a relatively smaller field of view and more individual images n may be needed to provide 360° coverage. In an alternative embodiment, the speed of rotation setting is synchronous to the predetermined frame rate of video camera 106. In an embodiment, video camera assembly 105 includes pan mechanism 113 configured to determine an angular position of video camera assembly 105 about pan axis 112 and method 300 further includes registering adjacent ones of the plurality of images using at least one of the position encoder and the field of view. In another embodiment, acquiring 304 a plurality of images includes acquiring a first image having a first field of view and acquiring a second image having a second field of view wherein the first and second fields of views overlap. The area of overlap includes the same content information in two adjacent images. The content is used to register the adjacent images to produce a seamless transition from one image to the next adjacent image. Using the overlaps between all the adjacent images in the plurality of images acquired during a rotation of video camera assembly 105, a panoramic view of the area up to 360° around video camera assembly 105 is formed. The encoder portion of pan mechanism 113 and tilt mechanism 115 permits closed loop control of the pan rotational speed during image acquisition. The rotational speed is maintained substantially constant, which permits one or more of a plurality of types of motion compensated deblurring of the images to be applied. Controlling the speed of rotation of video camera assembly 105 during image acquisition to a substantially constant speed permits use of a deblurring algorithm that uses less computing resources to accomplish the deblurring than a deblurring algorithm that must account for a variation of the rotational speed and apply multiple corrections to the plurality of images as they are acquired or in a post-processing step.

Method 300 further includes selecting a zoom setting to select a field of view for the plurality of images. In another embodiment, video camera assembly 105 includes tilt mechanism 115 configured to rotate the video camera about tilt axis 114 to a plurality of tilt angles. The tilt angle may be used to determine a field of view during acquisition of the plurality of images and may be used to select a deblurring algorithm to use during acquisition. For example, with a zero tilt angle wherein video camera 106 is pointed substantially horizontally, blurring occurs substantially linearly across the images. When the tilt angle is increased, blurring becomes more arcuate across the images. In one embodiment, the tilt angle is used to select a different deblurring algorithm that corresponds to the determined tilt angle. In another embodiment, a term of the deblurring algorithm is dependent on the tilt angle to determine the amount of correction to apply to the images.

As will be appreciated based on the foregoing specification, the above-described embodiments of the disclosure may be implemented using computer programming or engineering techniques including computer software, firmware, hardware or any combination or subset thereof, wherein the technical effect is providing panoramic video coverage of an area of interest using a single video imager rotating about its pan axis and acquiring images that are registered with each adjacent image to generate a seamless panoramic view. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a video surveillance system provide a cost-effective and reliable means for enabling an operator to continuously monitor an area of interest with reduced fatigue due to intense concentration on a moving video representation of the area.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components.

While the disclosure has been described in terms of various specific embodiments, it will be recognized that the disclosure can be practiced with modification within the spirit and scope of the claims.

What is claimed is:

1. A video camera assembly comprising:
a pan mechanism rotatable about a pan axis;
a video camera mounted on said pan mechanism such that said video camera is rotatable about the pan axis; and
a controller communicatively coupled to said pan mechanism and said video camera, said controller configured to:
control the rotation of said video camera about the pan axis at a predetermined speed;
acquire a plurality of images from said video camera at a predetermined rate; and
display the acquired images panoramically.

2. A system in accordance with claim 1 wherein the predetermined speed in maintained substantially constant.

3. A system in accordance with claim 1 wherein said controller is further configured to continuously rotate said video camera about the pan axis.

4. A system in accordance with claim 1 wherein said controller is further configured to register an image of the plurality of images with a next sequentially acquired image.

5. A system in accordance with claim 1 wherein said controller is further configured to register an image of the plurality of images with a next sequentially acquired image using an image content of the overlap.

6. A method of operating a video camera assembly that includes a video camera and a pan mechanism, the pan mechanism configured to rotate the video camera about a pan axis, said method comprising:
rotating the video camera about the pan axis;
acquiring a plurality of images from the video camera during the rotation wherein the plurality of images includes an overlapping field of view; and
outputting a panoramic view of the acquired images.

7. A method in accordance with claim 6 wherein rotating the video camera about the pan axis comprises selecting a speed of rotation setting.

8. A method in accordance with claim 6 wherein rotating the video camera about the pan axis comprises determining a speed of rotation setting based on a field of view setting.

9. A method in accordance with claim 6 wherein rotating the video camera about the pan axis comprises determining a speed of rotation setting based on a predetermined frame rate of the video camera.

10. A method in accordance with claim 6 wherein the video camera assembly includes a pan axis position encoder configured to determine an angular position of the video camera assembly about the pan axis, said method further comprising registering adjacent ones of the plurality of images using at least one of the position encoder and the field of view.

11. A method in accordance with claim 6 wherein acquiring a plurality of images comprises:
acquiring a first image having a first field of view; and
acquiring a second image having a second field of view wherein the first and second fields of views overlap.

12. A method in accordance with claim 11 further comprising registering adjacent images using an image content of the overlap.

13. A method in accordance with claim 6 wherein acquiring a plurality of images comprises motion deblurring the images based on a substantially constant rotational speed.

14. A method in accordance with claim 6 wherein the video camera assembly includes a zoom for defining a field of view of the camera and wherein acquiring a plurality of images comprises selecting a zoom setting to select a field of view for the plurality of images.

15. A method in accordance with claim 6 wherein the video camera assembly further comprises a tilt mechanism configured to rotate the video camera about a substantially horizontal axis to a plurality of tilt angles and wherein the method further comprises determining a field of view using a tilt angle of the tilt mechanism during acquisition of the plurality of images.

16. A video system comprising:
a video camera assembly including a video camera and at least one of a pan mechanism, a tilt mechanism, and a zoom for defining a field of view of the camera; and
a controller communicatively coupled to said video camera assembly, said controller is configured to:
rotate the video camera continuously about the pan axis at a substantially constant rotational speed during a first mode of operation;
acquire a plurality of sequential images from the video camera during the rotation wherein the plurality of images includes a field of view that each overlaps a field of view of sequentially adjacent ones of the plurality of images;
output the acquired images in a panoramic view; and
update the images in the panoramic view each n rotations, where n is a whole number.

17. A system in accordance with claim 16 wherein said controller is configured to at least one of receive a speed of rotation setting and determine a speed of rotation setting.

18. A system in accordance with claim 16 wherein said controller is configured to determine a speed of rotation setting based on a field of view setting.

19. A system in accordance with claim 16 wherein the video camera assembly includes a pan axis position encoder configured to determine an angular position of the video camera assembly about the pan axis and wherein said controller is configured to register adjacent ones of the plurality of images using at least one of the position encoder and the field of view.

20. A system in accordance with claim 16 wherein the video camera assembly further comprises a tilt mechanism configured to rotate the video camera about a substantially horizontal axis to a plurality of tilt angles and wherein said controller is configured to determine a field of view using a tilt angle of the tilt mechanism during acquisition of the plurality of images.
